(19) United States
(12) Patent Application Publication
(10) Pub. No.: US 2007/0246613 A1
(43) Pub. Date: Oct. 25, 2007

(54) Wire management and strain relief device

(76) Inventor: Matthew Kennedy, Montreal (CA)

Correspondence Address: Matthew Kennedy, 4152 B Clark, Montreal, H2W 1W9, CA

(21) Appl. No.: 11/632,544

(22) PCT Filed: Jul. 15, 2005
(86) PCT No.: PCT/CA05/01112

§ 371 Date: Jan. 16, 2007

(30) Foreign Application Priority Data
Jul. 16, 2004 (CA) 2475261

(51) Int. Cl. F16L 5/00

(52) U.S. Cl. 248/56

(57) ABSTRACT

The invention relates to a wire management device (1) for organizing a group of wires wherein each wire (5) is held separately so that placement, wire selection, and retrieval of individual wires is facilitated without disturbing other wires in the assembly; the invention can be used as part of a system of like devices, arranged sequentially, that prevents tangling of the wires and organizes them along a desired length without the use of conduit or supports, although the device can also be used in conjunction with a variety of support means (20). The invention is configurable to be fixable to panels or sheet material for applications in office systems and aerospace, and can be fashioned into an assembly to organize wire into compact spools (80). The invention is configurable as a strap that can be formed into a compact assembly when the two ends are fastened together to form a compact device for wire management, and can be attached around table legs, ducts, etc.

### BACKGROUND OF THE INVENTION

Wire management solutions are required to organize wiring and cabling for electronic equipment and networks for utilitarian and aesthetic purposes. Wire management is a broad domain involving organizing wire to makes access and identification easier, bundling or grouping wires to make a compact and neat assembly to prevent tangling or potential damage to stray wires, and improving overall appearances. Generally the wires are physically directed and supported by the solution. Wire management also involves in some applications protection of the wire or integrity of the power or communication lines through housing the wires or providing strain relief from tension placed on a wire. The dual functions of utility and aesthetics are generally met in the same solution.

Applications of wire management solutions are found for home entertainment and computers, for office networks on or within office furniture, wall and flooring systems, and for the transportation industry, will special consideration for aerospace. Generally, requirements are met through the use of conduit, typically either extruded plastic or bent sheet metal, that run the entire length of the wire groups, through the use of racking systems, typically made of bent metal rod or wire stock, and through the use of grommets or clips for wire pass through in walls, panels, bulkheads, tables, and the like, or to support to a surface.

Conduit is specifically intended to encase wires in a housing to offer protection and to guide runs of wire along their length between points. In addition, conduit generally hides the wire, making neater appearances. Conduit is often inexpensive, but to be effective it should cover the wires at all points along their length, therefore a lot of conduit is required. Typically, a wire must exit the conduit at some point at its terminals to connect to equipment and sockets, so coverture is generally not complete. Conduit is problematic in that it is labor intensive to install, sometimes requiring heavy equipment for cutting and shaping, and it is generally difficult to make neat connections between joints with it, especially if they are oriented in different directions. The use of special joint parts facilitates jointing but adds extra cost and inventory. Installation location of conduit is typically dependant on it being attached to something like walls or within furniture panels. Conduit also bundles wire groups, which causes tangling of wires that make wire selection and retrieval difficult. Due to its enclosure, access to wires within conduit creates difficulties where frequent installation and removal of wire occurs. When no longer required at a location, due to renovations for example, conduit is generally not re-used or recycled and adds a lot of waste to landfills. In addition, conduit is generally considered to be as unattractive as disorganized wires. Its usefulness applies to applications where long term protection of undisturbed wire groups is required in concealed or out-of-view locations.

Racking systems made of bent wire stock, injection molded plastic or extruded elastomer are generally used in light duty applications and are typically mounted on the underside of office desks or within network cabinets. They typically function to support wire groups or bundles in trays or frames that offer light, uncovered protection by keeping wiring off floors or away from areas where abrasion or pinching can occur, such as between the back of a desk and a wall or away from network cabinet doors. In some instances in network applications, wires are individually supported near terminals to guide a wire from a terminal to a certain wire group where they are bundled together and directed to a location. In other instances, extruded channels hold wires individually in sets within fixed runs of determined length. Racking systems help to make wire management neat and organized, but are limited to localized support at specific locations where they are mounted to. Wires that must pass to locations where racks are not available must do so unsupported and therefore without a means for management. Racking systems are generally bulky and unattractive as well, and as a result are generally never placed on a working surface, such as an office desk, laboratory table, or assembly table where electronic and power equipment is used.

Wire management grommets, bushings, fairleads and clips are generally used in pass through applications where wiring passes through a hole, or aperture, in a support structure typically in a form of sheet material like tables or bulkheads to offer support, protection from edges in support structure, strain relief, isolation, or a combination thereof. The grommet collects groups of wires and typically provides a form of protective lip or guard at its extremities to prevent cutting or abrasion on the wires from edges at the aperture in the sheet material. Bushings may offer an element of strain relief for a single wire when fixed to a support structure. In some cases clips are used as a spacer or protective barrier to keep wires off the walls of the interior of a support structure in pass through applications such as in a bulkhead or through conduit, or to insulate them from touching any other surface in general as in high voltage lead applications. Some wire clips also support a number of wires individually to keep them from touching each other as well. Most clips require a combination of parts to achieve this result or must be inserted into a support structure or grommet to provide the clamping pressure required to keep the wires in the assembly and to keep the assembly supported in general; this is especially true of applications that provide a positive connection with the wire to provide strain relief. Some permit deflection of the body material to allow access of a wire into a hole fashioned with the intention to support a specific wire. Wire management grommets and clips are now typically injection molded, inexpensive parts that are removable, re-usable, and recyclable that are capable of organizing or supporting wires at specific locations, that may provide an element of strain relief or isolation of wires, but otherwise provide no protection to a wire along its length with the exception of restraining or supporting a wire at points that may prevent damage to the lengths between them by restricting contact to physical elements in the surrounding environment.

None of the inventions disclosed in the cited patents are intended to accomplish the task of wire retention of multiple wires in individual wire holes in a compact device fashioned specifically to manage a group of wires to organize them, prevent tangling and facilitate installation, selection and retrieval of individual wires without disturbing the assembly of other wires to the device or requiring disassembly or de-installation of the device, where the wire management device and wires at the device are made into a compact assembly unsupported by other means. Moreover, in all cited patents showing incidences where the material at the point of entry to those devices providing a passage to a hole of predetermined size intended to support a single wire and a method of capture of that wire, and the material surrounding the hole is integral, that is one and the same, the deflection of the body material permits only a specific diameter of wire, with allowances for tolerance, into that hole that would provide also some from of gripping or clamping pressure, or permit as well at most a very limited range of smaller diameters of wire that would be supported loosely with no element of gripping, strain relief or positive connection between the device and the wire that would prevent them from moving in relation to one another. This lack of prior art is true also of a modular system of multiple instances of such devices that provide wire management along specific lengths of wire groups without the use of support means, conduit, racking or some other channeling.

### SPECIFICATION

The invention disclosed herein was designed with the intention to accomplish the task of wire retention of multiple wires in individual wire holes of predetermined size fashioned specifically to manage a group of wires to organize them, prevent tangling and facilitate installation, selection and retrieval of individual wires without disturbing the assembly of other wires to the device or requiring disassembly or de-installation of the device, where the wire management device and wires at the device are made into a compact assembly unsupported by other means, as claimed in claim 1. The invention provides a passage to a hole of predetermined size intended to support a single wire and a method of capture of that wire within an integral body of material that would prevent, by virtue of static friction, them from moving in relation to one another, as disclosed in claim 1; the deflection of the body material at flanges within the hole permitting the entry of wires of any size smaller than the hole to be gripped by this material, therefore providing a condition of positive connection between the device and the wire essential for retention of this wire at the device is disclosed in claim 2. An assembly of multiple instances of such devices provides wire management along specific lengths of wire groups without the use of support means, conduit, racking or some other channeling is claimed in claim 3. These features form the essence of the art disclosed herein. These features are significant since the assembly of wires to the devices functions to provide wire management without conduit or support means external to this assembly, therefore the directions the wire assembly is directed toward is not dictated by the fixed position of conduit or support means, and the modular nature of the devices in this assembly permit multiple wire groups to come together or branch off at any point in the assembly. Further dependent claims disclose a variety of support means, installation applications and procedures, and configurations that further the usefulness of the invention and broaden its application.

The wire management device and system and/or configuration of devices disclosed herein were designed to provide a solution for effective and aesthetic wire management. The preferred embodiment of the device is a single entity integrally made of pliable material, such as thermoplastic elastomer, to permit elastic deformation of the device body or features on the device that are both temporal and impermanent; these deformations allow the entry of wires into wire holes of predetermined size in the device, deformations which afterwards relax to a neutral state, holding the wires within. The neutral state is defined herein as the state or orientation of features in the device as they were at manufacture and that the device maintains or returns to without the presence of external forces. The addition of pliable flanges extending from the wire holes provides a measure of positive connection to a range of wire diameters.

The device may be fashioned with variations in design, and in a variety of colors and translucencies, to make the product attractive both at point of purchase and in use. Color may be employed at discreet portions around wire holes to code the wire holes to discriminate the wires within them. Other signifiers like symbols may also be employed for the same. The material may be fashioned in a variety of durometers to impart stiffness or softness, or stickyness, depending on requirements of application and the specific features may have specific durometers that can be facilitated by the process of co-injection, overmolding or assembly, or stiffness variation imparted by thickness of material as fashioned. Where requirements for specific durometers, or degrees of hardness and stiffness, are met in an embodiment that requires co-injection, overmolding or assembly, certain portions like the general device body can be made of relatively stiffer and harder material, such as polypropylene (an olefin), and other portions that require deflection and elastic properties as disclosed in this specification can be made of softer, more pliable material, such as thermoplastic olefin, a variant of thermoplastic elastomer that shows excellent molecular adhesion to other olefins such as polypropylene. An embodiment of the device would be a compact form such as a disk or plate. In other embodiments, the device can be fashioned from pliable material such as nylon or polyester strapping with fastening-straps, wherein the pliable material binds around a wire to contain and positively hold it. Furthermore, the device may be fashioned as a linear series of components, fastened together, or an integral linear line with appended wire holes and adjacent portions.

Features of the wire management device disclosed herein are considered novel and effective because they allow the organization of a group of wires in an compact assembly by individually introducing each wire into a wire hole, likewise permitting individual selection and retrieval, that holds the wire in the device by static friction through the interference fit of the pliable material of the device at the wire hole and the wire. Static friction is defined herein as the forces that act between the surfaces of the wire and those at the wire hole on the device that prevent the wire and device from moving relative to each other while at a state of rest within the assembly. Interference fit, alternatively described as friction fit, is defined as the assembly of a wire to the device, wherein the wire causes a degree of elastic deformation of the material at the wire hole, creating forces than act circumferentially around a wire to hold that wire in place; it is a cause of static friction. The properties of pliable materials such as thermoplastic elastomer also cause a grip effect to the wire, especially when the wire is also encased in elastomeric material, since the use of these materials create incidences of molecular attraction and a vacuum seal to the wire that increase static friction as defined herein.

These wire holes of predetermined size may also feature flanges at the holes to grip the wires to permit the same use of static friction to hold a wire smaller in diameter than the actual hole and, being made of the same pliable material as the device body at the wire holes although generally thinner, these flanges may flex to accommodate a range of wire diameters no larger than the nominal diameter of the predetermined hole. The friction fit holds the wires to the device, such that the device supported by the wires may hang freely in a determined position on the wires without sliding, and likewise provides strain relief of the wires to the device in a configuration where the device is supported by other support means. Support means can generally be fastened to a central hole in the device deployed either by inserting support means into the hole by deforming the pliable material surrounding the hole or by means of a passage to the hole whereby support means an enter from a perimeter of the device to be fastened to the hole. In other embodiments the support means can fastened to the device around the perimeter of the device.

The wire management device may also be used in a modular system of wire management devices arranged sequentially along a group of wires to form an assembly that prevents the wires from tangling, as each wire is held in each device in a dedicated hole. The system is considered modular in that the number of like devices required to perform the tasks of wire management and support may vary depending on need, and is flexible to permit changes in the number to reflect changes in need.

In the application of wire management where the devices are not supported by external support means or encased in conduit, the group of wires and the devices work together to make wire management and organization possible: The devices guide and hold the wires individually, but together in a compact order; the group of wires support the devices, the orientation of which dictates the location of the devices. What is significant is that the invention can accomplish wire management without the use of fixed conduit, support or channeling of any kind, which affords a greater degree of flexibility and therefore application as a result of the wire group not being forced into a direction determined by a those entities; the wire groups are free to be oriented in any direction.

The use of the invention is not limited to applications where the device is unsupported, however; a number of support means are disclosed to allow the device to be fixable to tables, extruded channels, grommets, apertures within sheet material, and the like. Typical fasteners are used to fix the device to support means or support structures, such as screws, adhesive tapes, rivets, or snap-fits. It is likely that an assembly will consist of a mixed environment of supported and unsupported devices, as requirements dictate.

The assembly of devices to the wire group can be of any length. The length of this assembly is determined by the number of devices used and the distance between them, which are all choices made by an individual making the assembly and as such allows flexibility of the application so that the assembly can be adjusted to meet external constraints or user desire. These external constraints can be accommodated in varying degrees of success by the number of devices used in the modular system, and therefore in function of management and support of wires the number of devices is adjustable to meet the degree of success required. These constraints include, but are not limited to, controlling wire deviation in general and catenary specifically, number and position of support means, number of supported devices required to hold a group of wires of a certain weight (as each supported device also shares a portion of the weight of the wire group), number of wires to number of wire holes (more devices with predetermined numbers of wire holes may be required at a location to accommodate the number of wires as seen at a cross-section of that location), and budget. The modular nature of the assembly of devices allows an individual to acquire a specific number of devices for use in this assembly that perfectly suits the requirements of the task.

In some cases the number of devices will affect the degree of effectiveness of the assembly. While an individual device will provide wire management, a greater number of devices will increase the grouping effect and decrease wire deviation the closer the devices are brought together; in effect the assembly will provide a flexible wire group held together as if in a tube, but without any actual conduit or other enclosing means. When these devices are supported, the greater number of them and their close proximity will reduce catenary effect on the wires caused by gravity. The closer the devices are placed in proximity to one another along a group of wires, the less those wires will experience sag from a catenary effect or otherwise deviate from the hypothetical center line that runs through the centers of the devices that support the wires. An individual can adjust quantity and proximity of devices to reach a satisfactory level of grouping, or controlled deviation, in the assembly. An additional control method is to locate the wire holes at two different relative diameters on alternate devices so that the wires are pre-stressed in tension in a truss formation to keep a wire group taught, reducing catenary and wire deviation caused by outside forces.

If these devices are also supported to a support structure by support means, the greater number of devices will also increase strain relief on the wires, especially important when forces are applied to the assembly, such as they might experience when G-force is applied in an aerospace application. However, more devices also increase weight and cost of the assembly which may also be a critical factor; the difference is seen as a tradeoff between potentially positive and negative factors, but a solution may be found by the quantitative, modular nature of the invention that can produce measurable qualitative results.

The devices can be made to be more robust with features to increase strain relief by adding flanges or wire supports to the device at the wire hole such that fewer devices are needed to provide the same amount of strain relief than a device without these features. This would be useful for certain applications such as in aerospace where the reduction in number of devices means important weight savings.

The assembly of wires can also have branches that deviate from any portion along the grouping of wires; wires can enter or exit the assembly at any point without any alteration of the form or features of the devices as manufactured and intended. The sequence of devices does not necessitate a linear arrangement, and devices can be fixed to any wire or wires that form a group at any point on those wires, such that a wire group could split into sub-groups that are directed in different directions and individual wire management devices in the system can be fixed to any of the sub-group branches of a wire group. A simple illustration of this is a single grouping of wires that is split into two branches to make a ‘Y’, each of the three arms of that assembly being a sub-group of wires that are held separately by wire management devices. Individual wires can be transferred from one group to another. In this manner can the system of devices accommodate the arrangement of wire groups with extensive tributaries and estuaries, as might be found on or within furniture panels in office systems. The device also accommodates this organization without special directional joints between devices as components of this wire management system.

Another application of the invention is to use two such devices fastened to a standoff between them to serve as a form of spool to wind excess wire around. The wire simply snaps into a wire hole in one device, is wound around the standoff, and is snapped into the device on the other side, providing enough static friction to keep the wire wound on the spool. This wire spool may be used independently or as part of a wire-grouping system.

Another embodiment of the invention is a wire management device comprising of a strap whereupon along its length are wire holes at intervals, surrounded by the same pliable material as the main body of the invention fashioned as curved-arms extending from the main body of the strap whereupon a passage to the hole is fashioned by the two arms of the strap coming into proximity of each other. The fastening ends of the straps can be brought together and fastened thereto by a number of fastening means, such as by rivet, nut and bolt, Velcro, or by snap-fit boss and hole made out of the same pliable material in the preferred embodiment. A ratcheting rack and pinion system as employed by tie-wraps may also be employed, whereupon one end having a rack of ridges insertable into a ratchet housing internally comprising a flexible member that deflects as the ridges of the other end pass through one way but locks the two ends in place should the two ends be made to pull apart. When the straps ends are brought together to form the compact assembly, the wire holes may be positioned on either the inside or outside of the assembly, however in either case by bringing the two ends together a central hole is formed that can be used to fasten around an object in the environment as support means as described and disclosed above. An embodiment fashioned with all of the wire hole positioned on one side of the strap can be wrapped around a table leg, or a air duct, to make an assembly of the strap supported by objects in the environment as a form of skeletal conduit, whether it be in an office at a desk, or overhead along duct-work, for example. When the wire holes are positioned to the interior in the assembly of the strap, the assembly becomes very compact and could serve as a bundler of wires that also isolates each one for ease of selection and retrieval. As a strap, an embodiment of the device is formed from pliable thermoplastic or elastomer as with most of the embodiments, however this embodiment can also be fashioned from fabric, such as nylon or polyester strapping, and is especially beneficial to be fashioned from elastic stretch fabric, comprising of a portion of Lycra or the like, such that the wire-hole strapping can expand to greater degree to allow a broader range of wire diameters that could be positively held by the wire holes. In any case, embodiments comprising of fabric would have as a fastening means at the entrance of the passage to the wire holes a fastening-strap fashioned from Velcro or like hook and pile fastening means, wherein such fastening means can be comprised of the same material of the wire management device at manufacture. The fastening-strap is deployed as a means for holding a wire within a wire hole and cinching the wire tight within the wire hole, but can be loosened to accommodate a broad range of wire diameters. As a fabric, each wire-hole strapping can be fashioned from material of a different color, stitched to the main strap body, to permit ease of identification of individual wires held by the invention. In another embodiment, the entire wire management device strap, wire-hole strapping, and fastening-strap is formed from the same length of material comprising of fabric with both positive and negative fastening means (such as hook and pile means like Velcro) on opposing sides of the fabric strap, such that during manufacture a length of the stock material can be looped together and stitched at the base of the loop, whereupon the loop is cut to form the wire-hole strapping and fastening-strap together in a single entity. A succession of these operations would form a flower appearance in final assembly when the two ends of the wire management device as a strap are fastened together into a closed assembly as described.

An improvement of the fabric strapping material would be a integral bead of pliable elastomeric material formed on a surface of the strapping at the wire-hole strapping to allow a greater degree of friction to the wire held within the fastening-strap and wire-hole strapping and to support means held within the central hole of the assembly of the two ends of the strap of the invention. The elastomer is advantageously deformable to allow tighter contact with the wire and allow a greater degree of wire diameters to be held in place within the wire hole.

The wire management device may also be comprised of components that, when assembled, comprise a wire management device and/or system. The device may take a linear form, following the lines of the wires, and yet remain compact in terms of diametrical space around a collection of wires. Each component, comprising of at least one wire hole and associated portions, would be fastenable to an adjacent component by means such as a snap-fit bead inserted into a snap-fit cavity on the other. Such a snap-fit assembly would permit the assembly of components to flex, aided by the pliable nature of the material, to allow installation to follow a non-linear course, such as around corners. Likewise, even flat devices may be fastened together with stand-offs in a similar fashion to control their orientation to one another.

In summary, the device provides a broad range of wire management solutions that are aesthetic and effective and configurable to a number of requirements. The device accomplishes wire management minimally with no bulky parts and organizes wire groups neatly without needing to hide or enclose the wires.

### DESCRIPTION

A wire management device as illustrated in FIG. 1 is comprised of a device body 1 comprising of a compact form, such as nominally flat, compact disk or plate, or group of branches fashioned or connectible together to form the device body 1, shown here as a compact disc with portions made of pliable material, a plurality of discreet wire holes 2 of predetermined size nominally disposed near a perimeter 3 of the device body 1 with narrow passages 4, narrower than the width of a wire 5 (shown as a section), between the perimeter 3 and each of the wire holes 2 such that the wire 5 may be forced to pass through a narrow passage 4, causing elastic deformation of the pliable material at the narrow passage 4, and be connectible and held circumferentially by a wire hole 2 by act of static friction between the surfaces of the wire 5 and the pliable material at the wire hole 2, wherein the pliable material deformed at the narrow passage 4 returns to a relaxed neutral state to further hold the wire 5 in the device by barring the narrow passage 4 to the wire 5 by virtue of it being narrower than the width of the wire 5 when in the neutral state, the plurality of wire holes 2 devised to hold individual wires 5 separate from each other to organize them and likewise hold the device body 1 in suspension on the wire 5 or wires 5 by the static friction. A flange 6 or flanges 6 extending from a hole perimeter 7 of a wire hole 2, directed toward the center of the wire hole 2 and nominally more thin and pliable than the general device body 1, act to hold a wire 5 smaller in diameter than the wire hole 2 by static friction, the flange 6 or flanges 6 being pliable enough to permit their elastic deformation 6′ to accommodate a range of wire diameters not larger than the diameter of the wire hole 2 or the diameter permitted by the elasticity of the hole perimeter 7 at wire hole 2.

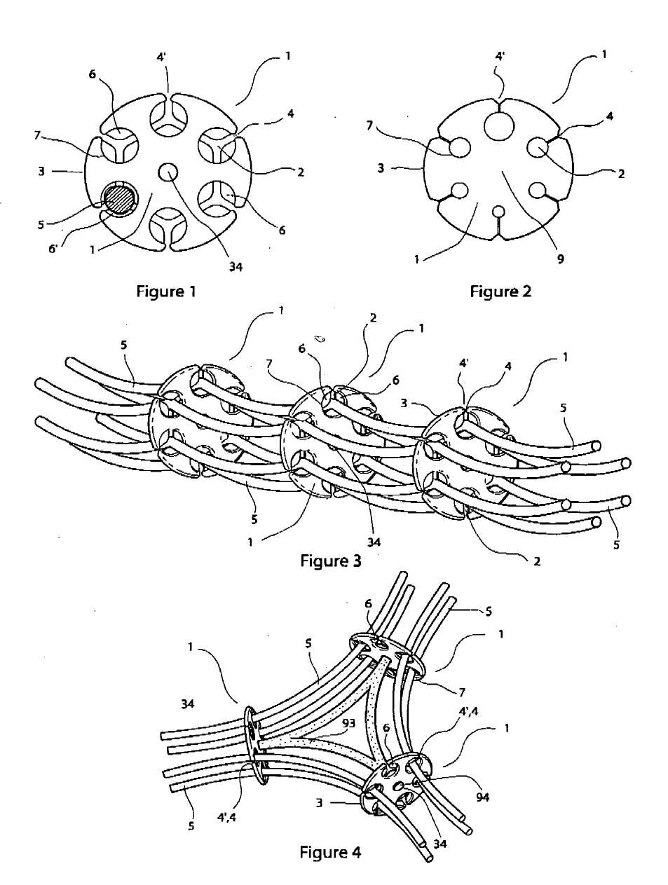

FIG. 2 depicts another embodiment of the device without the presence of flanges 6, in which the plurality of discreet wire holes 2 is comprised of a range of wire hole 2 diameters to permit wires of different diameters to be attached and benefitting from a measure of elastic deformation at the hole perimeters 7 to permit static friction of the material at the hole perimeter 7 to the wire 5 inserted therein. In such a configuration, the wire hole 2 diameters would typically be fashioned to match standard wire gauges, the sizes of which would be predicted by the application of the device. Chamfered or rounded edges at the perimeter entrance 4′ to a narrow passage 4 facilitates entry of a wire into the device body 1 in that the notch at the perimeter entrance 4′, created by the chamfering or rounding of the edges, permits a wire to register thereto in a funnel-like manner and permits the wire to be pushed into said narrow passage without slipping against an otherwise uniform perimeter 3. Due to the simplicity and lack of small details, the composition of the device as represented in FIG. 2 would benefit die-cut manufacturing.

As depicted in FIG. 3, the wire management device can be used as part of a system comprising a plurality of the wire management devices arranged sequentially along an assembly of wires 5 such that each wire 5 of the assembly at portions of its length is held individually by the devices at the wire holes 2 for organization purposes to prevent tangling of the wires 5 that therefore facilitates identification and allows a wire 5 to be added or removed from the system without interfering with the organization or assembly of other wires 5 connected to the system, thereby achieving wire management without the use of conduit.

FIG. 4 depicts an embodiment of the invention wherein the modular nature of the devices permits the system of devices to be comprised of multiple wire groups wherein wires 5 are exchanged from devices in one group to devices in another group to cross-link the wire groups. A joiner 93 may be employed to connect the devices together to maintain a certain organization and reference to each other. The joiner 93 would typically connect to a device body 1 at a support hole 34 by fastening means shown as a snap-fit bead 94 comprising an extremity of the joiner 93 in FIG. 4 that passes through the support hole 34, and as the bead 94 is larger than the support hole 34 it causes elastic deformation of the material thereto, arriving to the posterior side of the device body 1 locked in place having passed through the support hole 34.

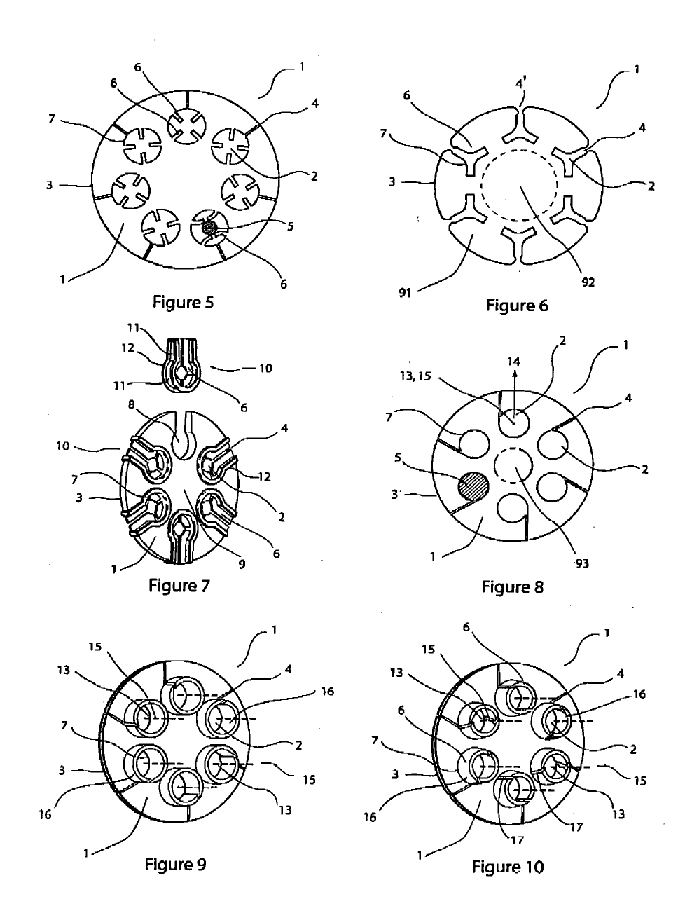

The invention can be manufactured by several different processes to achieve desired features and material properties, both as an integrally manufactured, one-part device, or as an assembly of parts. Injection molding thermoplastic elastomer is the preferred process of manufacture however the invention can also be fashioned by die-cutting pliable material or extruding thermoplastic elastomer, as depicted in FIG. 5. Each method employs procedures and designs that enable the pliability of discreet features to be controlled so that some are more pliable, whereas others may be stiff. Some elastomers are sticky to the touch and as such may be employed to provide strain relief of a wire 5 (shown as a section) within a wire hole 2 by imparting a greater degree of static friction between these features. Pliable materials employed in die-cutting may include rubber, neoprene, or any other cast, extruded or expanded foam sheet material.

One method of controlling pliability of discreet features is to vary part thickness, as depicted in FIGS. 1, 2, 3, 4, 7, 11, 19, 20, 21, 27 through 38, and 42 through 44. A wire management device can comprise a device body 1 of varied thickness to permit thinner portions such as flanges 6 to be pliable, such as to allow elastic deformation of the narrow passage 4 to permit entry of a wire 5 to a wire hole 2, and other, thicker portions to be rigid to make a device body 1 that provides support of the wires 5 captive at flanges 6 extending from the thicker material at hole perimeters 7. In die-cut and extruded parts, the variance in thickness can only occur as shaped in a die and in directions perpendicular to forces used in manufacture, as depicted in FIG. 5. Injection molding can employ variance in material thickness within the mold cavity. FIGS. 1, 5, 19, and 20 show the deflection 6′ of flanges 6 caused by elastic deformation when a wire is inserted within a wire hole 2. FIG. 8 shows elastic deformation of a hole perimeter 7 when a wire 5 is inserted within a wire hole 2 that does not have flanges wherein the wire hole 2 was fashioned to match the gauge of the wire 5 to permit an element of static friction between them.

Varying material durometers, as permitted by the injection molding processes of co-injection and overmolding, permit portions of lower durometer 91 to be pliable (generally below durometer 80 Shore A), such as to allow elastic deformation of the narrow passage 4 to permit entry of a wire 5 to a wire hole 2, and other portions of higher durometer 92 to be more rigid (generally above durometer 80 Shore A), to make a device body 1 that provides support of the wires 5 at the wire holes 2, as depicted in FIG. 6.

Controlling pliability may also be possible by making an assembly of parts as depicted in FIG. 7, wherein the device body 1 comprises a rigid frame of material with a plurality of keyholes 8 near the perimeter 3, the keyholes 8 being narrow near the perimeter 3 and wider toward the center 9 of the device body 1, to permit the assembly of wire holders 10 made of pliable material thereto, each of the wire holders 10 fashioned in the shape of a keyhole 8 with a fastening channel 11 around the wire holder perimeter 12 to be fixable within the keyholes 8 by deforming portions of the extremities of the channels 11 of the wire holders 10 while inserting it into place within the keyholes 8 wherein the deformed portions will return to a neutral state, each of the pliable wire holders 10 comprising the features of the narrow passage 4, the hole perimeter 7 and portions extending therefrom, such as flanges 6.

The invention may also exhibit other features to help provide greater degrees of wire capture and strain relief.

To improve wire capture and retention, FIG. 8 depicts an embodiment of the invention wherein the narrow passage 4 does not extending radially from the adjacent wire hole 2 with a clear view of the center 13 of the wire hole 2 such that it provides a measure that prevents a wire 5 (shown as a section) from being forced out of the wire hole 2 by a force perpendicular 14 to an axis 15 corresponding to the center 13.

To improve strain relief, FIG. 9 depicts an embodiment of the invention wherein a pliable wire support 16 extending from a wire hole 2 at a portion of its hole perimeter 7, extending nominally parallel to the axis 15 of the wire hole 2, is intended to further support a portion of a wire 5 located in the wire hole 2 to prevent pressure being placed on a narrow portion of the wire 5 at the hole perimeter 7 of the wire hole 2 should a force be exerted on the wire 5, and to provide greater surface contact between the wire 5 and the device to provide more static friction, serving to provide a degree of strain relief.

FIG. 10 depicts a wire support 16 that extends from the perimeter 3 of the wire hole 2 in a conic fashion toward the axis 15 to provide a narrow sleeve nominally smaller in diameter than the wire 5, the insertion of the wire 5 therein causing elastic deformation of the wire support 16 to create a circumferential force on the wire 5 that increases static friction and functions to grip the wire 5 to provide a greater degree of strain relief. The wire supports 16 can be fashioned with relief slits 17 to separate portions of wire supports 16 so as to functions as flanges 6 to permit ease of deflection as required.

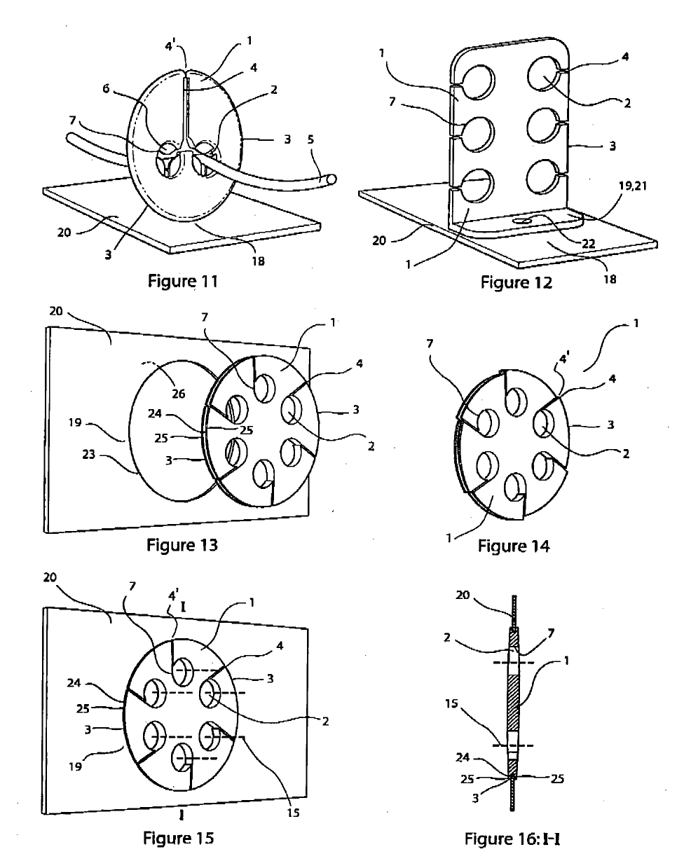

The invention can also be employed to isolate a wire 5 or wires 5 from its surrounding environment. As depicted in FIG. 11, the device is restable on a surface 18 by the edge of the perimeter 3, the device providing a measure to prevent a wire 5 from coming into contact with the surface 18 or objects in the surrounding environment by providing necessary distance at the perimeter 3 of the device between the surface 18 or objects and wire 5 within the wire hole 2.

Although the preferred embodiment of the device permits effective usage without any external support means 19, other embodiments may employ features so the invention can interface with support means 19 fixable to a support structure 20, or directly to support structures 20 themselves; the term support means 19 is used herein to be inclusive of support structures 20 as well. The various forms of support means 19 fixable to support structures 20 utilize fastening elements such as screws, rivets, adhesive tapes, and suction cups, and these can be used interchangeably depending on application and mating surface properties. As depicted in FIG. 12, support means 19 can be an integrally fashioned part of the invention; support means 19 depicted as a foot 21 that descends from a portion of the perimeter 3 of the device that is fixable to a surface 18 on a support structure 20 by fastening means such as a screw that passes through a mounting hole 22 in the foot 21.

As depicted in FIG. 13, the invention can be configured to be mountable to an aperture 23 (or hole) in a support structure 20 such as sheet material. The aperture is circumferentially connectible to the device within a channel 24 integrally disposed around the perimeter 3 of the device and be fixable thereto, the device pliable enough to allow elastic deformation of sidewalls 25 on one side of the channel 24 to pass through the aperture 23 and to relax into a neutral state on the posterior side 26 of the aperture 23, whereby the support means 19 at the aperture 23 is held between sidewalls 25 on both sides of the channel 24 circumferentially.

FIG. 14 depicts added means for strain relief, wherein a portion of the material at the perimeter 3 near an entrance 4′ to a passage 4 to a wire hole 2 of the device is deflected inwards when the device is inserted into the aperture 23 creating clamping pressure to the wire 5 within the wire hole 2 that adds a high measure of strain relief.

FIGS. 5 and 16 show a wire management device fixed to support means 19, installed in an aperture 23 of a support structure 20 through the procedure as described in the text correlating to FIGS. 13 and 14. FIG. 15 shows a perspective view of the installation, FIG. 16 is a section view I-I of this installation, showing the aperture 23 captive between sidewalls 25 of a channel 24 at the perimeter 3 of the device.

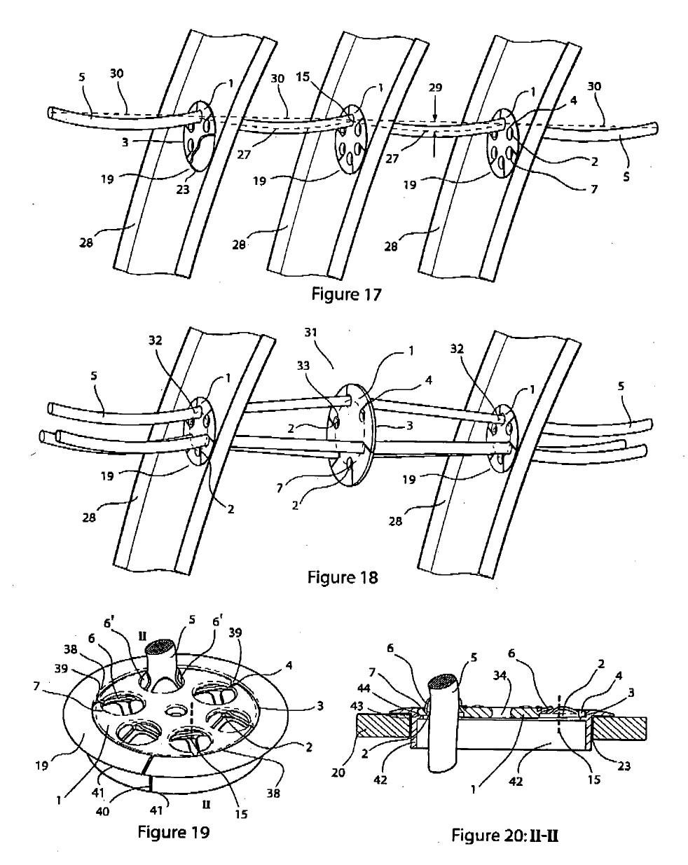

FIG. 17 depicts a system of plural devices 1 supported by support means 19 in close proximity to control catenary 27, the support means 19 depicted as apertures 23 (or holes) in airframes 28 in a cut-away isometric view of an aircraft fuselage; the closer the devices are to one another, the more they are able to control the extent of catenary 27, which is defined as deviation 29 of a single wire 5 from the hypothetical centerline 30 between devices that passes through each of the devices coincident to the axes 15 at wire hole 2 in each device where the wire 5 is connected, and although generally thought of as sag in a line in tension as a result of gravity on a wire supported at two points on its length, the term as used herein is broadened to include any deviation 29 from this hypothetical centerline 30 caused by external forces, including a G-force as might be experienced in an aircraft.

Another method of controlling wire deviation 29 is to create a truss structure 31 with a group of wires 5 and system of plural devices 1 that includes some external support means 19, as depicted in FIG. 18. The wire holes 2 are disposed in a circular array around a center point at each device, the system of devices comprising two configurations of devices, one with an array of small diameter 32 referencing the wire holes 2, and one with an array of large diameter 33 referencing the wire holes 2, such that they are positioned alternately in the system (as in 32,33,32,33, etc.) to create a truss structure 31 when the wires 5 are assembled to the devices at the wire holes 2 that pre-stresses the wires 5 to control catenary 27 and deviation 29 of the wires 5 from a hypothetical center line 30 that passes through the axes 15 of each wire hole 2 in the system. In this depiction, every alternate device has an array of small diameter 32 and is supported by a support structure 20, shown here as a portion of an aircraft airframe, and between them are devices with an array of large diameter 33 are permitted to connect freely to the group of wires 5 without external support means, although support means 19 may be employed there as well.

Further support means 19 can constitute a bracket fixable to both the invention and a support structure 20 (not depicted).

FIG. 19 depicts support means 19 that, at an interior perimeter 38, is connectible to the device nominally around the perimeter 3 of the device, whereby the device is pliable enough to be elastically deformed into a channel 39 within the interior perimeter 38 of the support means 19 and be held therein, wherein the support means 19 has a wire passage 40 that exits along a portion of the interior perimeter 38 to an exterior perimeter 41 to facilitate the entry of wires 5 (wire 5 is shown as a section in perspective) connectible to the device through the wire passage 40 of the support means 19. Support means 19 can be fashioned as a grommet 42 connectible to a support structure 20, such as a table, shelf, or cabinet panel.

FIG. 20 depicts a section view of an assembly of the device 1 within a grommet 42 in a support structure 20, wherein support means 19 in the form of a ledge 43, upon which the device at the perimeter 3 rests, within an interior channel 44 of the grommet 42 placed in an aperture 23 in the support structure 20 fashioned to allow the passage of wires 5 (wire 5 is shown as a section) through the support structure 20 via the grommet 42.

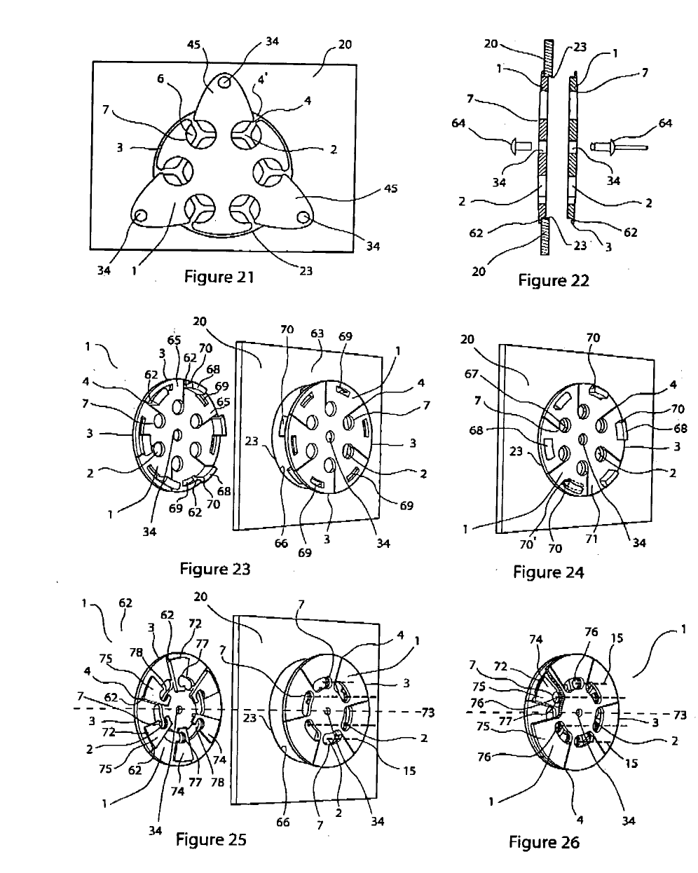

FIG. 21 depicts support means 19 comprising a plurality of straps 45 extending beyond the nominal perimeter 3 of the device, centrally locating the device over an aperture 23 in the support structure 20, the straps 45 fixable to a surface 46 of the support structure 20 by fastening means at support holes 34 on each strap 45 connectible to like support holes 34 on support structure 20 with fastening means.

As assembly of two devices 1 and a support structure 20 can provide support means, as depicted as a section view in FIG. 22, wherein the two devices 1 are placed on opposing sides of an aperture 23 in the support structure 20 made of sheet material, wherein a portion of each the devices is restable on an interior surface of the aperture 23 by way of a support ledge 62 on each of the devices nominally near and within the perimeter 3 of the invention and within the perimeter of the aperture 23, fixable together at the aperture 23 by fastening means uniting the two devices 1 to form an assembly, the perimeters 3 of each device generally extending beyond that of the aperture 23 such that when joined together by the fastening means the perimeters 3 vice against the respective structural surfaces 63 on opposing sides of the sheet material securing the assembly in place; FIG. 22 also depicts fastening means consisting of a fastener 64, illustrated as a two-part rivet assembly, that holds the two devices 1 together by passing through support holes 34 located at the centers of each device 1 and being fixed thereto.

FIG. 23 depicts an assembly that creates support means wherein the support ledge 62 of each device 1 consists of a plurality of support ledges 62 fashioned to interlock to those on the other device 1 within the aperture 23, by means of a support ledge 62 on one device fitting within the gap 65 between two support ledges 62 on the other, such that the combination of support ledges 62 on both interlocked devices 1 nominally fills the circumference of the interior perimeter 66 of the aperture 23 and rests against and within the entirety of the interior perimeter 66, the interlocking configuration support ledges 62 fitted into gaps 65 of the assembly has the effect of preventing the sheet material 20 from cleaving the two devices 1 apart when a force is applied to either. When assembled, the material at the perimeter 3 of each device 1 vices against respective structural surfaces 63 of support structure 20, keeping the assembly captive.

FIG. 24 shows the same assembly of devices installed at the aperture as described in FIG. 23. FIG. 24 depicts an assembly that creates support means wherein fastening means comprises an extension 68 of the support ledges 62 of one of the devices 1 such that they pass through the aperture 23 and clear through voids 69 in the other device body 1, each support ledge 62 having a locking lip 70 at it's extremity, nominally thicker than the general support ledge 62 body that deflects 70′ as the locking lip 70 passes through one of the voids 69 and comes to rest in a neutral state on a posterior surface 71 of the other device 1 such that the two devices 1 are considered locked together through the aperture 23 of the sheet material 20 as the locking lip 70 of each of the support ledges 62 locks against the posterior surface 71. The mating of interior surfaces 67 is held captive by the interlocked joining of the locking lips 70 of one device 1 to the respective posterior surfaces 72 on a conjoined device 1 through the voids 69.

FIG. 25 depicts an assembly that creates support means wherein the aperture 23 and the perimeter 72 of the collective support ledges 62 are both circular in shape, wherein the support ledges 62 are fully supported circumferentially and evenly at the interior perimeter 66 of the circular aperture 23 to provide a nominally even distribution of forces on the invention and the aperture 23 of the sheet material 20 to reduce localized strain at a portion of either material when forces are applied to either; the device bodies 1 rotate in opposition at a centrally disposed axis 73 such that each device has, as fastening means, at an extended portion of a support ledge 62 a locking hook 74 that rotates into a cavity 75 between a locking hook 74 and a device body 1 on the other device, the termination of which results in showing a clear passage 76 from each wire hole 2 in one device 1 to a corresponding wire hole 2 in the other such that the central axes 15 of each pair are coincident. FIG. 26 shows the same assembly of devices connected together, not showing the support structure 20 sandwiched between them for clarity, and a section removed to reveal the interlocking locking hooks 74.

FIGS. 25 and 26 also depicts an assembly that creates further locking means wherein an extremity of a locking hook 74 is a tight notch 77, positioned over one of the wire holes 2, whereat the entrance 78 to the tight notch 77 deflects to allow the passage of a wire 5 into the tight notch 77 whereby the entrance 78 relaxes to a neutral state, holding the wire 5 in the tight notch 77 to further provide static friction between the wire 5 and the devices in the assembly as the devices rotate in opposition to each other and terminate in a locked, assembled position.

FIGS. 1, 3, 4, and 19 through 41 depicts a support hole 34 in the device disposed to fasten to support means 19 whereby a portion of the support means 19 is fixable thereto.

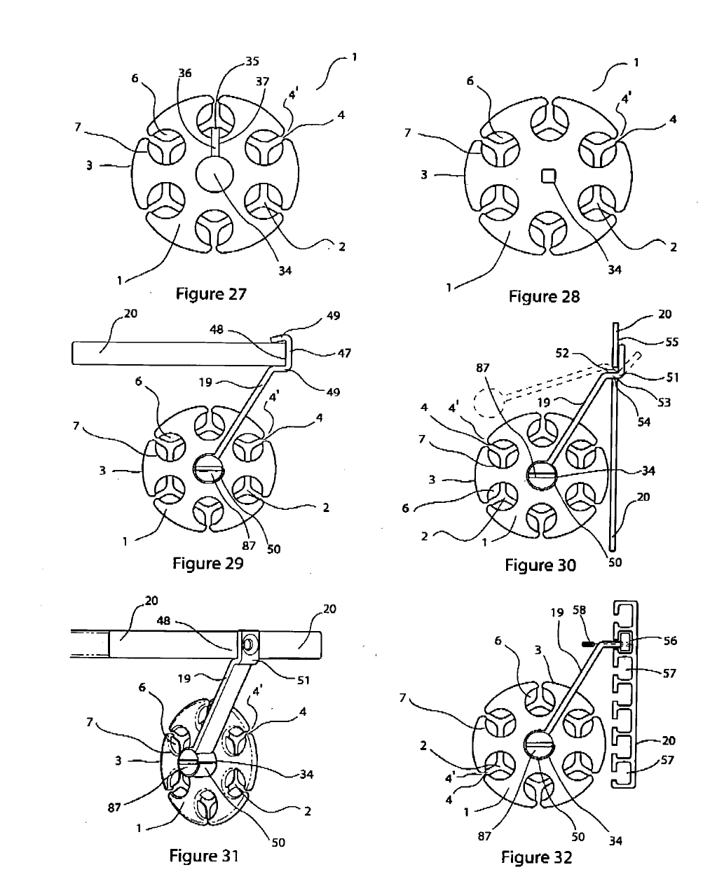

FIG. 27 depicts a wire passage 35 allows access from a perimeter 3 of the device to the support hole 34 to facilitate the use of the support hole 34 as an extra wire hole 2 when the invention is not connected to support means 19 at said support hole 34; the wire passage 35 is depicted as a nominally closed channel consisting of a tearable web of material 36, nominally thinner than the device body 1, between the sidewalls 37 of the wire passage 35 that can be torn to deploy the wire passage 35.

FIG. 28 depicts the support hole 34 as nominally shaped, such as square-shaped, to prevent the rotation of the device on an axis within the support means 19 where it is fixable to the device.

FIG. 29 depicts support means 19 comprising a hook detail 47 fashioned at an extremity disposed for fastening to a support structure 20, generally in the shape of the letter C, connectible to an edge 48 of the support structure 20 whereby the edge 48 of the support structure 20 is restable within the C-shaped hook detail 47 and generally held in compression by deflecting arms 49 comprising the C-shape of the hook detail 47. A portion of the support means 19 at a distal extremity from the fastening extremity (such as hook detail 47) is a device mounting point 50 connectible to the device body by fastening means, such as by fastening a binding screw assembly 87 and 88 to the device body 1 at the support hole 34 together to the support means 19 at the device mounting point 50.

FIG. 30 depicts support means 19 comprising a hook detail 51 fashioned at an extremity, generally in the shape of the letter L, for attaching the device into a slot or channel 52 within the support structure 20 such that an extremity of the L-shaped hook detail 51 enters the slot or channel 52, pivots anteriorly at a fulcrum 53 on a lower surface 54 of the opening of the slot or channel 52, and braces at a state of rest against a posterior surface 55 of the support structure 20 at the slot or channel 52 when a moment applied to the device causes the device to pivot on the fulcrum 53.

FIG. 31 depicts support means 19 as a hook detail 51 fashioned at an extremity, generally in the shape of the letter L, whereby a surface on the L-shaped hook detail 51 rests against an edge 48 of the support structure 20, the support means 19 fixable thereto by fastening means.

FIG. 32 is a section view depicting support means 19 as a profile detail 56 fashioned at an extremity fits into a compatibly shaped channel 57 in the support structure 20 that permits only lateral movement of the support means 19 within the channel 57 in the support structure 20; the support means 19 is fastenable to the support structure 20 at the channel 57 by fastening means 58, such as a set-screw, that prevents the lateral movement of the support means 19 along the channel 57.

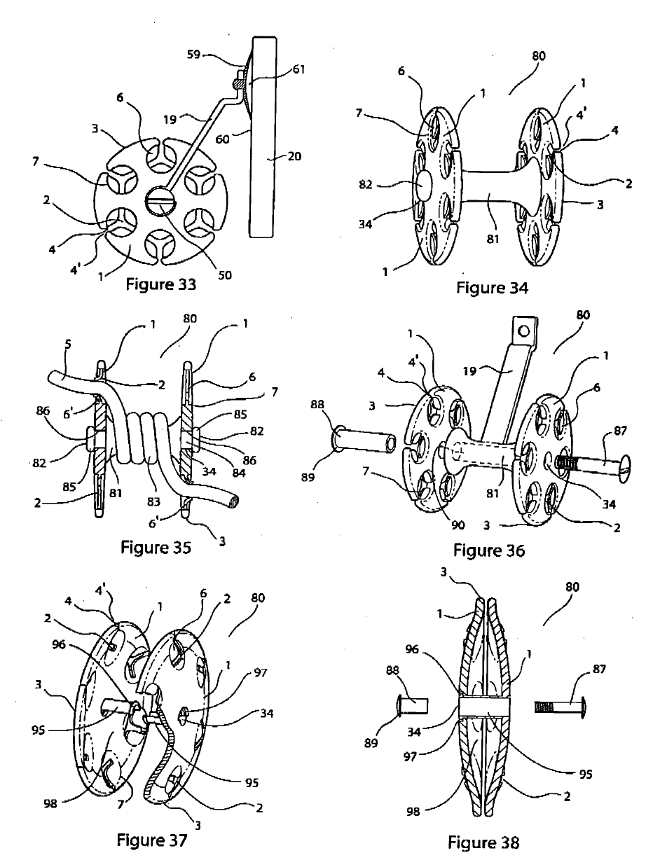

FIG. 33 is a section view depicting a portion of support means 19 as a suction cup 59 at an extremity that permits attachment of support means 19 to a smooth, flat surface 60 of a support structure 20 by way of surface cohesion created by a vacuum 61 between the suction cup 59 and the surface 60. Alternatively, the support means 19 may be attached to a support structure by other means, such as adhesive, magnets, or hook and pile.

The invention can also be configured as a wire spool to wind wire around.

FIG. 34 depicts a configuration wherein a wire 5 (not shown) is fixable at either end of a wire spool 80 to wire holes 2 in an assembly of two devices 1 and a standoff 81 fastened together by fastening means at a centrally disposed support hole 34 in each device 1 to opposing extremities 82 of the standoff 81, nominally larger than the support hole 34, to prevent the devices 1 from moving along the length of the standoff 81, in such a way to allow a wire 5 at a portion of its length at one extremity to be held by the wire hole 2 in one device 1, whereby a length of the wire 5 is coiled around the standoff 81 as a means for compact storage of the wire 5, this wire coil 83 being held in place by placing a portion of the wire 5 at the other extremity into a wire hole 2 on the other device 1 on the opposing end of the standoff 82 where it is held captive.

FIG. 35 is a section view of the assembly as described in FIG. 34 with the devices in section, depicting an extremity 82 of the standoff 81 having an extension 84 with a pronounced lip 85 that forms a channel 86 between the pronounced lip 85 and the extremity 82 such that the pronounced lip 85 is forced to pass through a support hole 34 in the center of a device 1 disposed to fasten to the standoff 81, the pronounced lip 85 being nominally larger than the support hole 34 so that when passing through the support hole 34, the pronounced lip 85 deflects the pliable material of the device 1 at the support hole 34, the pliable material returning to the neutral state within the channel 86 where it is considered fastened in place.

FIG. 36 is an alternative configuration of the wire spool assembly wherein a binding screw consisting of two parts, one part being an externally threaded screw 87, the other part being an internally threaded tube 88 with a securing flange 89 at its posterior extremity, fastens the assembly together as each part of the binding screw individually passes through a support hole 34 on a device 1 at opposite ends of the assembly and through a centrally disposed hole 90 in the standoff 81 between them wherein they will come together and vice the components into an assembly. A standoff 81 may be fashioned with support means for fastening to a support structure 20.

FIG. 37 depicts an alternate embodiment of the invention wherein a central boss 95 is fashioned at a support hole 34 within a wire cavity 98 on an interior portion of a concave device body 1. FIG. 37 depicts the boss 95 as molded in as a contiguous part of the device body 1 of each device, the boss 95 fashioned as a hemispherical protrusion insertable to a support hole 34 on a matching second device body 1 that also has a hemispherical boss 95 insertable to the first device body 1 at a support hole 34 thereat. At a distal end of said boss 95 is a snap-fit bead 96 that passes through said support hole 34 on said matching device body 1, deforming the pliable material around it and exiting at a relief trough 97 where it comes to rest in a fixed position, said deformed material returning to a neutral, relaxed position, whereupon the two conjoined device bodies are considered fixed together, whereupon a wire spool standoff 81 is formed by the connected bosses 95. FIG. 38 depicts a section view of the assembly of the fixed devices, showing in particular the wire cavity 98 that can be deployed to house a wire wound around a wire spool standoff 81, the conjoined bosses 95 acting as said standoff 81 to wind a wire 5 around. As an added measure of fixing, a binding screw assembly 87 and 88 can be inserted through said support holes 34 if the bosses do not fill completely the support holes 34.

FIG. 39 is an alternative embodiment of the invention fashioned as a strap formed of stiff but pliable material such as nylon polyamide wherein, like a conventional tie-wrap, said strap comprises the main body 1 of the invention, with a ratcheting rack 99 and pinion 100 fastening means allows the opposing two ends 110 of the tie-wrap to fasten together into a compact assembly and lock, upon which curved-arms 101, comprising of flanges 6, hole perimeter 7, and extend and come into proximity to each other to form a passage 4 leading to a wire-hole 2, said curved-arms 101 fashioned of the same pliable material as the main device body 1 of the device-as-strap, said curved-arms 101 being pliable enough to allow the passage of a wire 5 into the wire-hole 2 and be deformable enough to allow a range of wire 5 diameters into the wire-hole 5. Advantageously, the curved-arms 101 extend from a relief post 102 between them and the main body 1 of the strap to prevent the action of fastening the two ends 110 of the strap together into a compact assembly from influencing the deflection of the curved arms 101, preventing a wire 5 from being loosened therefrom. Alternatively, individual wire brackets 103, comprising of a channel body 104 and curved arms 101, in turn comprising of flange 6, hole perimeter 7, wire hole 2, and passage 4, are connectible to the main body 1 by passing a free end 110 through the channel body 104 where it is slid along the strap device body 1 and held captive thereupon when the two ends 110 of the strap device body 1 are joined at the ratcheting rack 99 and pinion 100. Advantageously, bumps 105 will hold the wire brackets 103 captive in place along the strap device body 1, the material of the wire brackets 103 and/or bumps being pliable enough to allow the passage of the wire brackets 103 when a degree of force is applied, where otherwise the brackets 103 would be kept captive between bumps 105.

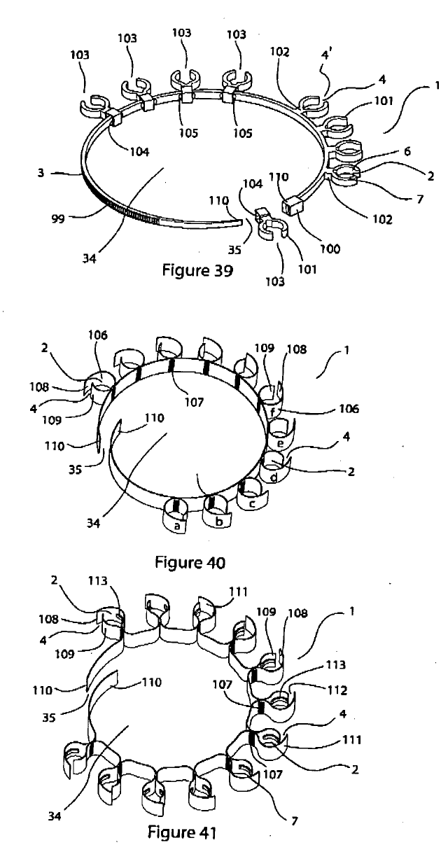

FIG. 40 is an alternative embodiment of the invention wherein the device body 1 is fashioned as a strap formed of strapping fabric whereupon wire-hole straps 106 are stitched 107 upon, a portion of which comprises a fastening-strap 108, typically fashioned from hook and pile fastening means or the like, to close the ends of the entrance 4 to a wire hole 2 by fastening to said hook and pile fastening means at the material at the opposing end 109 of the passage, the material pliable enough to cinch tight around a wire 5 to hold it in place within the wire hole 2, and to close the ends 110 of the main device body 1 of the strap together to form a compact assembly. These wire-hole straps 106 can be of differing colors a, b, c, d, e, f, etc., to differentiate the wires 5 within them. This embodiment is shown with the wire-hole straps 106 exterior to the main device body 1 of the invention as a strap to form a compact assembly such that support means 19 (such as a table leg or ventilation duct) can be fastened interiorly to the central support hole 34 within the main device body 1 without compressing the wires 5 at the wire-hole straps 106 during the assembly, however the wire-hole straps 106 can be deployed interiorly in the assembly as well.

FIG. 41 is an alternative embodiment of the invention device body 1 fashioned as a strap formed of hook and pile strapping fabric whereupon the entire wire management device body-as-strap 1, wire-hole straps 106, and fastening-strap 108 is formed from the same length of material comprising of fabric with both positive and negative (hook and pile) fastening means on opposing sides of the fabric strap, such that during manufacture a length of the stock material can be looped together and stitched 107 at the base of the loop, whereupon the loops are cut 116 to form a device body 1, a plurality of wire-hole straps 106 and fastening-straps together 108 in a single entity. A succession of these operations would form a flower appearance in final assembly when the two ends 110 of the wire management device 1 as a strap are fastened together into a closed assembly as described. The material of the strapping is pliable enough to cinch tight around a wire 5 to hold it in place within the wire hole by means of the fastening-strap 108 at the wire-hole strap 106, and to close the ends 110 of the main device body 1 of the strap together to form a compact assembly. The device, with a large support hole 34 as described in FIG. 41 can be fastened around a support structure 20, such as a table leg or duct, to form the assembly of the compact wire management device wherein a centrally located support-hole 34 is deployed within the device body 1 of the invention when the ends 110 of the strap are fastened together around such support structures 20. FIG. 41 also shows a bead 113 of pliable elastomer formed on a surface, such as by hot-melt of injection molding, to be employed as a superior means of static friction to a wire 5 held within the wire-hole 2 or to support means 19 held within the support-hole 34. The soft elastomer bead 113 is deformable to allow a greater degree of object diameters to be held within the respective wire-holes 2 or support-hole 34.

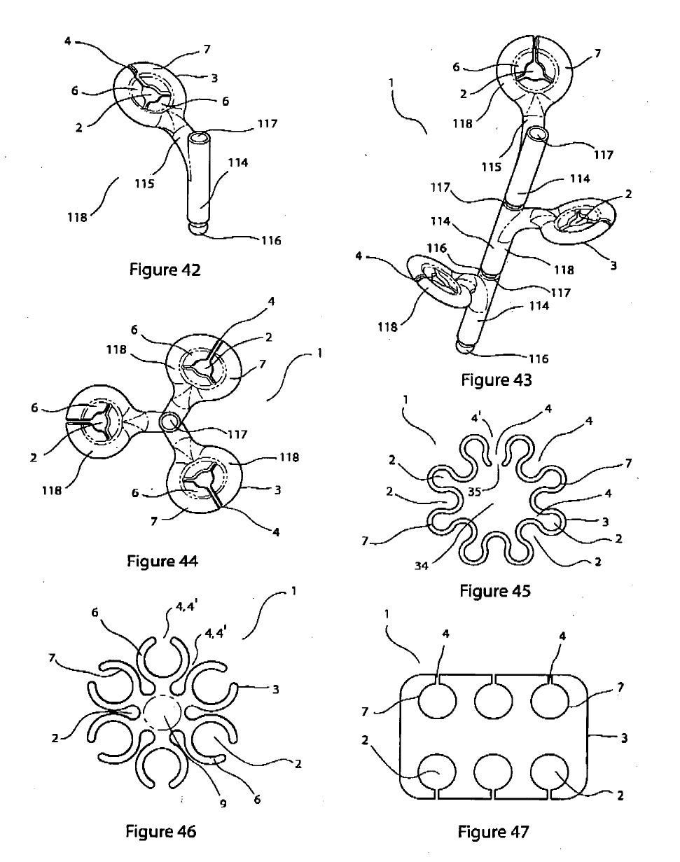

FIG. 42 shows a component 114 of an alternative embodiment of the device, wherein several components are fastened together to comprise a unified device body 1, each component having at least one wire hole 2 and a stem 115 with fastening means, shown here as a rotatable snap-fit bead 116 and a snap-fit cavity 117. An extension arm 118, connectible between said wire hole 2 and said stem 115 can be employed to create distance between the wire hole 2 and the stem 115 that allows added manageability when accessing a wire 5 at a wire hole 2. The wire hole 2 would generally be fashioned by a thickened hole perimeter 7 to the required strength and stiffness to support a wire 5 within a wire hole 2, that may include pliable flanges 6 to accommodate a wide variety of wire 5 diameters as disclosed. As disclosed, a narrow entrance 4 through the pliable material of the hole perimeter 7 would permit access of a wire 5 to a wire hole 2. FIG. 43 shows a device body 1 comprised of multiple components 114 to comprise a wire management device with multiple wire holes 2. Each component 114 is connectible to a neighboring component 114 by fastening means, shown in FIG. 43 as a rotatable snap-fit bead 116 on one component 114 inserted into a snap-fit cavity 117 in the next. The rotatable snap-fit bead may rotate, allowing the assembly of components 114 comprising the device body 1 to be flexible enough to allow the wire management system to bend into a radius or otherwise be oriented in deployment of the invention. The stems 115 may also be fashioned from pliable material to facilitate bending the assembly. FIG. 44 shows a top view of the assembly as presently disclosed showing the components 114 oriented to comprise a single device body 1 with a plurality of wire holes 2 in a compact assembly.

FIGS. 45, 46, and 47 are alternative embodiments of the invention as disclosed showing alternative designs.

1. A wire management device comprising: a device body comprising of a compact form with portions made of pliable material,
a plurality of discreet wire holes of predetermined size nominally disposed near a perimeter of the device body with narrow passages, narrower than the width of a wire, between said perimeter and each of said wire holes such that said wire may be forced to pass through a narrow passage, causing elastic deformation of said pliable material at said narrow passage, and be connectible and held circumferentially by a wire hole by act of static friction between the surfaces of said wire and said pliable material at said wire hole, wherein the pliable material deformed at said narrow passage returns to a relaxed neutral state to further hold said wire in the device by barring said narrow passage to said wire by virtue of it being narrower than the width of said wire when in said neutral state,
said plurality of wire holes devised to hold individual wires separate from each other to organize them and likewise hold the device body in suspension on said wire or wires by said static friction.

2. A wire management device as described in claim 1, wherein a flange or flanges extending from a perimeter of a wire hole, directed toward the center of said wire hole and nominally more thin and pliable than the general device body, act to hold a wire smaller in diameter than said wire hole by static friction, said flange or flanges being pliable enough to permit their elastic deformation to accommodate a range of wire diameters not larger than the diameter of said wire hole.

3. A wire management device as described in claims 1 or 2, wherein a wire management system comprises a plurality of said wire management devices arranged sequentially along an assembly of wires such that each wire of said assembly at portions of its length is held individually by said devices at said wire holes for organization purposes to prevent tangling of the wires that therefore facilitates identification and allows a wire to be added or removed from said system without interfering with the organization or assembly of other wires connected to said system, thereby achieving wire management without the use of conduit.

4. A wire management device as described in claims 1, 2 or 3, wherein a wire management device comprises a device body of varied thickness to permit thinner portions to be pliable, such as to allow elastic deformation of said narrow passage to permit entry of a wire to a wire hole, and other, thicker portions to be rigid to make a device body that provides support of said wires at said wire holes.

5. A wire management device as described in claims 1, 2 or 3, wherein a wire management device comprises a device body that has varied material durometers, as permitted by the injection molding processes or co-injection and overmolding, to permit portions with lower durometers to be pliable, such as to allow elastic deformation of said narrow passage to permit entry of a wire to a wire hole, and other portions with higher durometers to be more rigid to make a device body that provides support of said wires at said wire holes.

6. A wire management device as described in claims 1, 2 or 3, wire wherein the device body comprises a rigid frame of material with a plurality of keyholes near said perimeter, said keyholes being narrow near said perimeter and wider toward the center of the device body, to permit the assembly of wire holders made of pliable material thereto, each of said wire holders fashioned in the shape of a key with a channel around their perimeter to be fixable within said keyholes by deforming portions of the extremities of said channels of said wire holders while inserting it into place within said keyholes wherein said deformed portions will return to a neutral state, each of said pliable wire holders comprising the features of said narrow passage, said wire hole and portions extending therefrom.

7. A wire management device as described in claims 1, 2, or 3, wherein the device is made from a sticky elastomeric material that provides an element of strain relief by improving static friction.

8. A wire management device as described in claim 1, 2 or 3, wherein the device is an integrally injection molded thermoplastic elastomer material.

9. A wire management device as described in claim 1, 2 or 3, wherein the device is an integrally die-cut pliable material.

10. A wire management device, as described in claims 1, 2 or 3, wherein the device is an integrally extruded thermoplastic elastomer material.

11. A wire management device as described in claims 1, 2, or 3, wherein said narrow passage is not extending radially from the adjacent wire hole with a clear view of the center of said wire hole such that it provides a measure that prevents a wire from being forced out of said wire hole by a force perpendicular to an axis corresponding to said center.

12. A wire management device as described in claim 1, 2 or 3, wherein a pliable wire support extending from a wire hole at a portion of its perimeter, extending nominally parallel to the axis of said wire hole, is intended to further support a portion of a wire located in said wire hole to prevent pressure being placed on a narrow portion of the wire at the perimeter of said wire hole should a force be exerted on the wire, and to provide greater surface contact between the wire and the device to provide more static friction, serving to provide a degree of strain relief.

13. A wire support as described in claim 5, wherein said wire support extends from said perimeter of said wire hole in a conic fashion toward said axis to provide a narrow sleeve nominally smaller in diameter than the wire, the insertion of the wire therein causing elastic deformation of said wire support to create a circumferential force on the wire that increases static friction and functions to grip the wire to provide a greater degree of strain relief.

14. A wire management device as described in claims 1, 2 or 3, wherein the device is restable on a surface by the edge of said perimeter, the device providing a measure to prevent a wire from coming into contact with the surface or objects in the surrounding environment by providing necessary distance at the perimeter of the device between the surface or objects and wires within said wire holes.

15. A wire management device as described in claims 1, 2 or 3, wherein an aperture within support means is circumferentially connectible to the device within a channel integrally disposed around said perimeter of the device and be fixable thereto, the device pliable enough to allow elastic deformation of sidewalls on one side of said channel to pass through said aperture and to relax into a neutral state on the posterior side of said aperture, whereby the support means at said aperture is held between sidewalls on both sides of said channel circumferentially.

16. A wire management device as described in claim 15, wherein the material near a passage to a wire hole at the perimeter of the device is deflected inwards when the device is inserted into said aperture creating clamping pressure to the wire within said wire hole that adds a high measure of strain relief.

17. Support means as described in claim 15, wherein support means is sheet material.

18. A system of wire management devices, as described in claim 3, wherein the devices are supported by support means and in close proximity to control catenary.

19. A wire management device, as described in claim 18, wherein the wire holes are disposed in a circular array around a hypothetical center point at each device, the system of devices comprising two sizes of devices, one with an array of small diameter referencing said wire holes, and one with an array of large diameter referencing said wire holes, such that they are positioned alternately in the system to create a truss structure when the wires are assembled to the devices that pre-stresses said wires that controls catenary and deviation of wire from wire from a hypothetical center line that passes through said center points of each device in the system.

20. A wire management device as described in claim 3, wherein the modular nature of the devices permits said system of devices to be comprised of multiple wire groups wherein wires are exchanged from devices in one group to devices in another group to cross-link the wire groups.

21. A wire management device as described in claims 1, 2 or 3, wherein the device has support means mountable to a support structure.

22. A wire management device as described in claim 21, wherein support means is an integrally formed part of the device.

23. A wire management device as described in claim 21, wherein a support hole in the device is disposed to fasten to support means whereby a portion of said support means is fixable thereto.

24. A support hole as described in claim 23 wherein said support hole is nominally shaped to prevent the rotation of the device on an axis within the support means where it is fixable to the device.

25. A wire management device as described in claim 23, wherein a wire passage allows access from a perimeter of the device to said support hole to facilitate the use of said support hole as an extra wire hole when the invention is not connected to support means.

26. A passage as described in claim 25 that is nominally a closed channel consisting of a tearable web of material, nominally thinner than the device body, between the walls of the passage that can be torn to deploy the passage.

27. A wire management device as described in claim 21, wherein support means at an interior perimeter is connectible to the device nominally around said perimeter of said device, whereby the device is pliable enough to be elastically deformed into a channel within said interior perimeter of the support means and be held therein.

28. Support means as described in claim 27, wherein said support means has a wire passage that exits along a portion of said interior perimeter to an exterior perimeter on said support means to facilitate the entry of wires connectible to the device through said passage of said support means.

29. Support means as described in claim 21, wherein support means takes the form of a ledge, upon which the device at said perimeter rests, within an interior channel of a grommet placed in a hole in said support structure fashioned to allow the passage of wires through said support structure via said grommet.

30. Support means as described in claim 21, wherein support means comprises a plurality of straps extending beyond the nominal perimeter of the device, centrally locating the device over an aperture in said support structure, the straps fixable to a surface of said support structure by fastening means.

31. Support means as described in claim 21, wherein a hook detail is fashioned at an extremity, generally in the shape of the letter C, connectible to an edge of said support structure whereby said edge of said support structure is restable within said C-shaped hook detail and generally held in compression by deflecting arms comprising the C-shape of said hook detail.

32. Support means as described in claim 21, wherein a hook detail is fashioned at an extremity, generally in the shape of the letter L, for attaching the device into a slot or channel within said support structure such that an extremity of said L-shaped hook detail enters said slot or channel, pivots anteriorly at a fulcrum on a lower surface of the opening of said slot or channel, and braces at a state of rest against a posterior surface of said support structure at said slot or channel when a moment applied to the device causes the device to pivot on said fulcrum.

33. Support means as described in claim 21, wherein a hook detail is fashioned at an extremity, generally in the shape of the letter L, whereby a surface on said L-shaped hook detail rests against an edge of said support structure, the support means fixable thereto by fastening means.

34. Support means as described in claim 21, wherein a profile detail fashioned at an extremity fits into a similarly shaped channel in said support structure that permits only lateral movement of the support means at the profile detail within said channel in said support structure.

35. Support means as described in claim 34, wherein said support means at said profile is fastenable to said support structure at said channel by fastening means that prevents the lateral movement of said support means along said channel.

36. Support means as described in claim 21, wherein a suction cup at an extremity permits attachment of support means to a smooth, flat surface by way of surface cohesion created by a vacuum.

37. A wire management device as described in claims 1 or 2, wherein two such devices are placed on opposing sides of an aperture hole in sheet material, wherein a portion of each said devices is restable on an interior surface of said aperture hole by way of a support ledge on each of said devices nominally near and within the perimeter of the invention, fixable together at said aperture hole by fastening means uniting the two devices to form an assembly, the perimeters of each device generally extending beyond the aperture hole such that when joined together by said fastening means said perimeters vice against the respective surfaces on opposing sides of the sheet material securing the assembly in place.

38. An assembly as described in claim 37, wherein fastening means consists of a fastener that holds the two devices together by passing through holes located at the centers of each device.

39. An assembly as described in claim 37, wherein said support ledge of each device consists of a plurality of support ledges fashioned to interlock to those on the other device within said aperture hole, by means of a support ledge on one device fitting within the void between two support ledges on the other, such that the combination of support ledges on both interlocked devices nominally fills the circumference of the interior perimeter of the aperture hole and rests against and within the entirety of said perimeter, the interlocking configuration of the assembly preventing said sheet material from cleaving the two devices apart when a force is applied to either as the major surface planes of the sidewalls of the sheet material are not parallel and coincident to all aspects of the joint between the two devices.

40. An assembly as described in claim 39 wherein fastening means comprises an extension of said support ledges of one of said devices such that they pass through the aperture and clear through voids in the body of the other said device, each support ledge having a locking lip at it's extremity, nominally thicker than the support ledge body that deflects as said locking lip passes through one of said voids and comes to rest in a neutral state on a posterior surface of the other device such that the two devices are considered locked together against the aperture hole of said sheet material as said locking lip of each of said support ledge locks against said posterior surface.

41. An assembly as described in claim 37 wherein said aperture hole and said support ledges are both circular in shape, wherein the support ledges are fully supported circumferentially and evenly at the perimeter of said circular aperture hole to provide a nominally even distribution of forces on said invention and said aperture hole of said sheet material to reduce localized strain at a portion of either material when forces are applied to either.

42. An assembly as described in claim 41 wherein said devices rotate in opposition at a centrally disposed axis such that each device has, as fastening means, at an extended portion of a support ledge a locking hook that rotates into a cavity between a locking hook and a device body on the other, the termination of which results in showing a clear passage from each wire hole in one device to a corresponding wire hole in the other such that the central axes of each pair are coincident.

43. An assembly as described in claim 42, wherein an extremity of a locking hook is a tight notch, positioned over one of said wire holes, whereat the entrance to said tight notch deflects to allow the passage of a wire into said tight notch whereby said entrance relaxes to a neutral state, holding said wire in the tight notch to further provide static friction between said wire and the devices in the assembly as the devices rotate in opposition to each other and terminate in a locked, assembled position.

44. An embodiment of the invention as described in claims 1 or 2, wherein an assembly of two devices and a standoff is fastened together by fastening means at a centrally disposed support hole in each device to opposing ends of said standoff, nominally larger than said support hole, to prevent said devices from moving along the length of the standoff, in such a way to allow a wire at a portion of its length at one extremity to be held by said wire hole in one device, whereby a length of the wire is coiled around the standoff as a means for compact storage of the wire, this wire coil being held in place by placing a portion of the wire at the other extremity into a wire hole on the other device on the opposing end of the standoff.

45. Fastening means as described in claim 44, wherein an extremity of said standoff has an extension with a pronounced lip that forms a channel between the pronounced lip and said extremity such that said pronounced lip is forced to pass through a support hole in the center of a device disposed to fasten to said standoff, said pronounced lip being nominally larger than the support hole so that when passing through said support hole, said pronounced lip deflects the pliable material of the device at said support hole, said pliable material returning to the neutral state within the channel where it is considered fastened in place.

46. Fastening means as described in claim 44, wherein a binding screw consisting of two parts, one part being an externally threaded screw, the other part being an internally threaded tube with a flange at its posterior extremity, fastens said assembly together as each part individually passes through a support hole on a device at opposite ends of said assembly and through a centrally disposed hole in said standoff between them wherein they will come together and vice the components into an assembly.

47. A standoff as described in claim 44 fashioned from centrally disposed integral bosses of two exteriorly concave shaped wire management device bodies connectible to each other at said bosses to said support holes, the convex interiors of each device facing each other to form a cavity wherein wire can be wound around said standoff and concealed, the material of the device bodies pliable enough to permit the entry of a wire therein between said connected devices.

48. A wire management device as described in claim 23 wherein an alternative embodiment of the invention fashioned as a strap formed of strapping fabric whereupon wire-hole straps are stitched thereto, a portion of which comprises a fastening-strap, typically fashioned from hook and pile fastener or the like, to close the ends of the wire holes by fastening said hook and pile fasteners at the material at the opposing end of the passage together, the material pliable enough to cinch tight around a wire to hold it in place within the wire hole, and to close the ends of the main body of the strap together to form a compact assembly.

49. A wire management device as described in claim 48 wherein said wire-hole straps can be of differing colors to differentiate the wires within them.

50. A wire management device as described in claim 48 wherein a method of manufacture of the invention fashioned as a strap formed of strapping fabric comprises the entire wire management device strap, wire-hole straps, and fastening-strap to be formed from the same length of material comprising of fabric with hook and pile fastening means on opposing sides of the fabric strap, such that during manufacture a length of the stock material can be looped together and stitched at the base of the loop, whereupon the loop is cut to form the wire-hole strapping and fastening-strap together in a single entity. A succession of these operations would form a flower appearance in final assembly when the two ends of the wire management device as a strap are fastened together into a closed assembly as described. The material of the strapping is pliable enough to cinch tight around a wire to hold it in place within the wire hole by means of the fastening-strap at the wire-hole strapping, and to close the ends of the main body of the strap together to form a compact assembly.

51. A wire management device as described in claim 21 or 23 wherein the embodiment is fastened around support means to form the assembly of the compact wire management device wherein a centrally located support-hole 34 is deployed within the body of the invention when the ends of the strap are fastened together around such support means.

52. A wire management device as described in claim 48 wherein a bead of pliable elastomer is formed on a surface of said strap, such as by hot-melt or injection molding, to be employed as a superior means of static friction to a wire held within the wire-hole or to support means held within the support-hole 34, such that the elastomer is deformable to allow a greater degree of object diameters to be held within the respective wire-holes or support-hole.

53. An alternative embodiment of the invention as described in claim 23 fashioned as a strap formed of stiff but pliable material wherein said strap comprises the main body of the invention with fastening means to allow the opposing two ends to fasten together into a compact assembly and lock, whereon a plurality of wire brackets fashioned as curved-arms comprising said wire hole, hole perimeter, and flexible flanges extend, said wire brackets being pliable enough to allow the passage of a wire into the wire-hole and be deformable enough to allow a range of wire diameters into the wire-hole.

54. An embodiment as described in claim 53 wherein said wire bracket extend from a relief post between said main body and said wire bracket to prevent the action of fastening the two ends of the strap together into a compact assembly from influencing the deflection of the wire brackets, thereby preventing a wire from being loosened therefrom.

55. An embodiment as described in claim 53 wherein said wire bracket is fashioned as a separate entity from the main body of the invention, a plurality of which may be attached thereto with fastening means.

56. An embodiment as described in claim 55 wherein the means of fastening said wire bracket comprises a channel body extending from a portion of said wire bracket connectible to the main body by passing a free end of the strap forming said main body through the channel body where it is slid along the strap and held captive thereupon when the two ends of the strap device body are joined by fastening means.

57. A strap disclosed in the embodiment as described in claim 56 whereupon bumps are located to hold the wire brackets captive in place along the strap device body, the material channel body and/or bumps being pliable enough to allow the passage of the wire brackets when a degree of force is applied, where otherwise the brackets would be kept captive between bumps.

58. An embodiment as described in claim 53 wherein fastening means is a locking rack and pinion on respective ends of said strap.

59. An embodiment as described in claims 1, 2, or 3, wherein several components of an embodiment of the device are fastened together to comprise a unified device body with a plurality of wire holes, each component having at least one wire hole and a stem with fastening means connectible to adjacent components.

60. An embodiment as described in claim 59 wherein a rotatable snap-fit bead and a snap-fit cavity comprise separate ends of said stem, said rotatable snap-fit bead on one component being insertable into a snap-fit cavity in an adjacent stem, the rotatable snap-fit bead being free to rotate allowing the assembly of components comprising the device body to be flexible enough to allow the wire management system to bend into a radius or otherwise be oriented in deployment of the invention.

61. An embodiment as described in claim 59 wherein an extension arm, connectible between said wire hole and said stem can be employed to create distance between the wire hole and the stem that allows added manageability when accessing a wire at a wire hole.

62. An embodiment as described in claim 59 wherein the stems are fashioned from pliable material to facilitate bending the assembly.

63. An embodiment as described in claims 1, 2, or 3, wherein the compact form of the invention is a nominally flat disc or plate.

64. An embodiment as described in claims 1, 2, or 3, wherein portions of the material surrounding the wire holes are coded to individually discriminate the wire holes and subsequently the wires within them.
